(19) United States
(12) Patent Application Publication
(10) Pub. No.: US 2018/0067578 A1
(43) Pub. Date: Mar. 8, 2018

(54) DISPLAY APPARATUS WITH TOUCH DETECTION FUNCTION

(71) Applicant: Innolux Corporation, Miao-Li County (TW)

(72) Inventors: Shinji Konoshita, Miao-Li County (TW); Kazuyuki Hashimoto, Miao-Li County (TW)

(21) Appl. No.: 15/255,185

(22) Filed: Sep. 2, 2016

(51) Int. Cl. G06F 3/044

(52) U.S. Cl. CPC G06F 3/044

(57) ABSTRACT

A display apparatus with a touch detection function including a display medium including pixels and touch electrodes is provided. Each of the pixels including color regions arranged in a matrix with rows and columns, wherein each of the pixels has a first side (Px) along a row direction and a second side (Py) along a column direction. At least one of the touch electrodes includes conductive wires extending along the row direction, wherein at least one of the conductive wires includes a first portion and a second portion extending in different directions. The first portion crosses at least one pixel and serves as a hypotenuse of a right triangle with a first leg (Tx) parallel to the row direction and a second leg (Ty) parallel to the column direction, a ratio of lengths of the first leg (Tx) to the first side (Px) is not an integer.

### TECHNICAL FIELD

The disclosure relates in general to a display apparatus, and more particularly to a display apparatus with a touch detection function.

### BACKGROUND

In recent years, the development of a display apparatus equipped with a touch sensor is a huge breakthrough in the history of technology. Typically, the display apparatus having a touch sensor equips a plurality of translucent conductive materials such as indium tin oxide (ITO) as touch electrodes mounted on or integrated within a display device, such as a liquid crystal display device, so as to provide the display device a touch detection function and allow information input by using the touch sensor as a substitute for a typical input device, such as a keyboard, a mouse, and a keypad.

Currently, the display apparatus with the touch sensor is further required to have lower-resistance to achieve a smaller thickness, a larger screen size, or a higher definition. To reduce the sensor resistance, alternative conductive material, such as a metallic material other than ITO is effectively used for reducing the resistance of the touch electrodes.

However, using the metallic material to serve as the touch electrodes can cause moiré pattern to be seen due to the interference between pixels of the display device and the metallic material. How to minimize the effect of moiré and to keep the higher resolution of the display apparatus without affecting its display quality has become a prominent task for people in the technology field.

Therefore, it has become a prominent task for the industries to provide an advanced display apparatus with a touch detection function to obviate the drawbacks encountered in the prior art.

### SUMMARY

The disclosure is directed to display apparatus with a touch detection function.

According to one embodiment of the disclosure, a display apparatus with touch detection function is provided. The display apparatus includes a display medium and a plurality of touch electrodes disposed corresponding to the display medium. The display medium includes a plurality of pixels, each of the pixels including a plurality of color regions with different colors, arranged in a matrix with a plurality of rows and columns, wherein each of the pixels has a first side (Px) along a row direction and a second side (Py) along a column direction. At least one of the touch electrodes includes a plurality of conductive wires, the conductive wires extending along the row direction, wherein at least one of the conductive wires includes at least one first portion extending in a first direction and at least one second portion connecting to the first portion and extending in a second direction, and the first direction is different from the second direction. The first direction is different from the row direction and the column direction, and the second direction is different from the row direction and the column direction. The first portion crosses at least one pixel and serves as a hypotenuse of a right triangle with a first leg (Tx) parallel to the row direction and a second leg (Ty) parallel to the column direction, a ratio of a length of the first leg (Tx) to a length of the first side (Px) is n, and n is not an integer.

The above and other aspects of the invention will become better understood with regard to the following detailed description of the non-limiting embodiment(s). The following description is made with reference to the accompanying drawings.

### BRIEF DESCRIPTION OF THE DRAWINGS

FIG. 1A is a cross-sectional view of a display apparatus with a touch detection function according to an embodiment of the present disclosure;

FIG. 1B is a top view of the display apparatus as shown in FIG. 1A;

FIG. 2 is a top view of a display apparatus with a touch detection function according to another embodiment of the present disclosure;

FIGS. 3A and 3B are simplified cross-sectional views of a display apparatus according to an embodiment of the present disclosure, illustrating the shadow coverage of the conductive wires casted on the pixels of the display apparatus observed at different view angles;

FIGS. 4A and 4B are top views of a display apparatus according to an embodiment of the present disclosure, illustrating the shadow coverage of the conductive wires casted on pixels of the display apparatus respectively at a vertical view angle and at an oblique view angle;

FIGS. 5A and 5B are top views of a display apparatus according to another embodiment of the present disclosure, illustrating the shadow coverage of the conductive wires casted on pixels of the display apparatus respectively at a vertical view angle and at an oblique view angle; and

FIGS. 6A and 6B are top views of a display apparatus according to a comparative embodiment, illustrating the shadow coverage of touch detection electrodes casted on pixels of the display apparatus respectively at a vertical view angle and at an oblique view angle.

### DETAILED DESCRIPTION

Detailed descriptions of the embodiments of the disclosure are disclosed below with accompanying drawings. In the accompanying diagrams, the same numeric designations indicate the same or similar components. It should be noted that accompanying drawings are simplified so as to provide clear descriptions of the embodiments of the disclosure, and the following detailed description are exemplary and explanatory only and are not restrictive of the disclosed embodiments as claimed. Anyone who is skilled in the technology field of the disclosure can make necessary modifications or variations to the structures according to the needs in actual implementations.

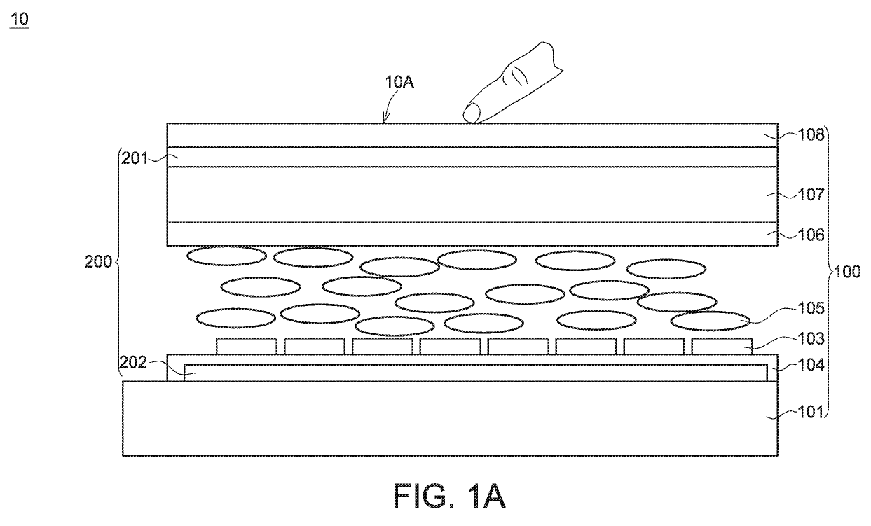

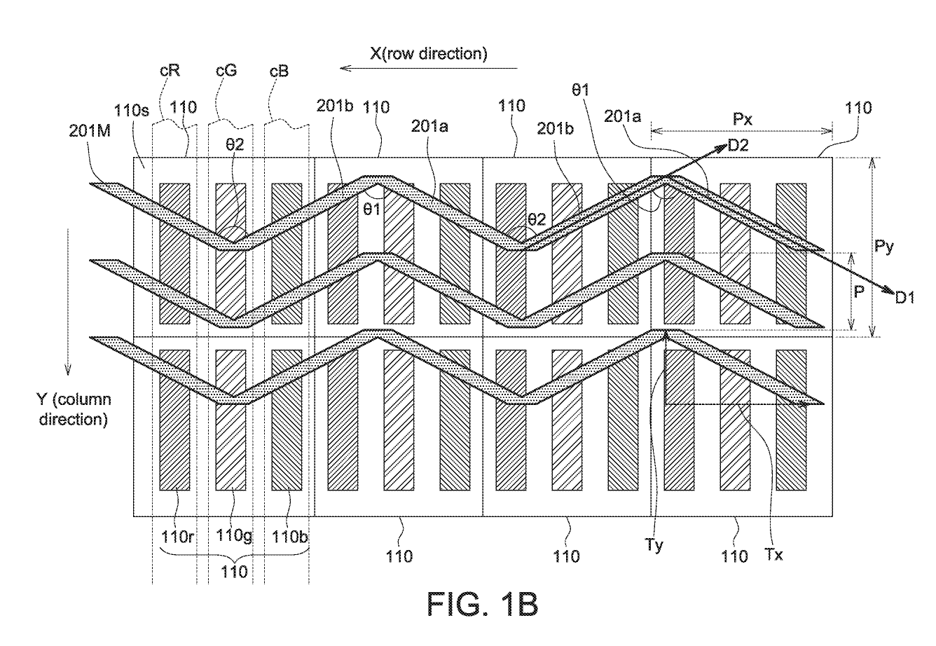

FIG. 1A is a cross-sectional view of a display apparatus 10 with a touch detection function according to an embodiment of the present disclosure. The display apparatus 10 includes a display medium 100 and a touch sensing structure 200. The display apparatus 10 has a touch surface 10A facing a user. In some embodiments of the present disclosure, the touch sensing structure 200 may be directly bound on the light existing surface of the display medium 100. In some other embodiments of the present invention, the touch sensing structure 200 may be integrated with the display medium 100.

In some embodiments, as shown in FIG. 1A, the display medium 100 may be a liquid crystal display (LCD) panel, and the display medium 100 may include a first substrate 101, a pixel electrode layer 103 formed on the first substrate 101, and a second substrate 107. A color filter 106 can be disposed on an inner side of the second substrate 107. A liquid crystal layer 105 can be disposed between the pixel electrode layer 103 and the color filter 106. A polarizing plate 108 can be disposed on an outer side of the second substrate 107. The first substrate 101 may be a TFT substrate, and the second substrate 107 may be a color filter substrate.

In some embodiments, the touch sensing structure 200 may include a plurality of touch electrodes, and the touch electrodes may include touch detection electrodes and drive electrodes. For example, as shown in FIG. 1A, the touch electrodes may include a plurality of touch detection electrodes 201 and a plurality of drive electrodes 202. The touch electrodes are disposed corresponding to the display medium 100 to provide touch function. As shown in FIG. 1A, the touch detection electrodes 201 and the drive electrodes 202 only show single-layered structures for simplicity. The touch detection electrodes 201 and the drive electrodes 202 can be patterned according to actual needs.

In some embodiments, the touch detection electrodes 201 can be formed on the second substrate 107 and between the second substrate 107 and the polarizing plate 108. In some embodiments, the touch detection electrodes 201 and the color filter 106 can be formed on different sides or the same side of the second substrate 107. The drive electrodes 202 can be formed on the first substrate 101 and between the first substrate 101 and the pixel electrode layer 103 and insulated from the pixel electrode layer 103 by an insulation layer 104.

According to some embodiments, the drive electrodes 202 and the touch detection electrodes 201 can three-dimensionally intersect with each other. For example, the touch detection electrodes 201 and the drive electrodes 202 are disposed on different planes; the touch detection electrodes 201 may extend along one direction, and the drive electrodes 202 may extend along another direction. However, the structure of the touch sensing structure 200 is not limited to this regard. In some embodiments, the touch detection electrodes 201 and the drive electrodes 202 can be formed on the same plane.

In the present embodiment, as shown in FIG. 1A, the touch detection electrodes 201 are formed on the second substrate 107, and the drive electrodes 202 are formed on the first substrate 101, thus constituting a hybrid type touch display device. Alternatively, in some embodiments of the present disclosure, both the touch detection electrodes 201 and the drive electrodes 202 can be formed on the second substrate 107, thus constituting an on-cell touch display device. Alternatively, in some embodiments of the present disclosure, both the touch detection electrodes 201 and the drive electrodes 202 can be formed on an additional substrate (not shown) disposed on the second substrate 107 towards the touch surface 10A, thus constituting an out-cell touch display device. In some embodiments of the present disclosure, the touch detection electrodes 201 and the drive electrodes 202 can be formed on the same substrate, or can be formed on different substrates. The positions of the touch detection electrodes 201 and the drive electrodes 202 can be exchanged according to actual needs.

In some embodiments of the present disclosure, the touch detection electrodes 201 and the drive electrodes 202 may be made of conductive materials, such as ITO or metal, and may be in the form of conductive wires. In the embodiments, the display apparatus 10 includes a substrate, and the conductive wires of the touch electrodes (the touch detection electrodes 201 and/or the drive electrodes 202) are disposed on the substrate. For example, in the present embodiment, the touch detection electrodes 201 and the drive electrodes 202 may include a plurality of conductive wires respectively formed on two different substrates, e.g. the second substrate 107 and the first substrate 101 respectively, extending along two different directions, and integrated within the display medium 100.

In the state in which the finger is in contact with (or in proximity of) the touch detection electrodes 201, electrostatic capacitance generated by the finger may interrupt the capacitance value between the touch detection electrodes 201 and the drive electrodes 202, and then the capacitive difference can be obtained, so as to provide the display apparatus 10 a touch detection function.

FIG. 1B is a top view of the display apparatus 10 as shown in FIG. 1A. In the embodiment, the display medium 100 includes a plurality of pixels 110, and each of the pixels 100 includes a plurality of color regions with different colors, arranged in a matrix with a plurality of rows and columns. Each of the pixels 110 has a first side (Px) along a row direction (X) and a second side (Py) along a column direction (Y). Each of the pixels 110 may further include a shielding region. For example, each of the pixels 110 may shape as a rectangle having three color regions 110r, 110g and 110b with three different colors, such as red (R), green (G), and blue (B). The color regions 110r, 110g and 110b of the pixel 110 can be arranged periodically in a predetermined order. In each pixel 110, the shielding region 110s is disposed between the color regions and surrounds the color regions. The shielding region 110s can be a black matrix. In the embodiment, the first side (Px) is the pixel pitch along the row direction, and the second side (Py) is the pixel pitch along the column direction. In some embodiments, color regions in the same column have the same color. For example, as shown in FIG. 1B, the color regions in column cR have red color, the color regions in column cG have green color, and the color regions in column cB have blue color.

According to some embodiments of the present disclosure, the touch detection electrodes 201 and/or the drive electrodes 202 may be in the form of conductive wires. The design of shapes and sizes of the conductive wires of the touch detection electrodes 201 will be described in the following as an example. Similar design can be made to the drive electrodes 202, and descriptions of the drive electrodes 202 will be omitted for simplicity.

In the embodiment, as shown in FIG. 1B, at least one of the touch electrodes, e.g. the touch detection electrodes 201, can include a plurality of conductive wires 201M. The conductive wires 201M can be overlapping with the pixels 110 and extending along the row direction (X). At least one of the conductive wires 201M includes at least one first portion 201a extending in a first direction D1 and at least one second portion 201b connecting to the first portion 201a and extending in a second direction D2, and the first direction D1 is different from the second direction D2. The first direction D1 can be different from the row direction and the column direction, and the second direction D2 can be different from the row direction and the column direction; In some embodiments, the conductive wire 201M can be a metal wire. For example, the metal wire can be made of Cu, Al, Cr or Ag. As shown in FIG. 1B, the first portion 201a crosses at least one pixel 110 and serves as a hypotenuse of a right triangle with a first leg (Tx) parallel to the row direction (X) and a second leg (Ty) parallel to the column direction (Y). A ratio of a length of the first leg (Tx) to a length of the first side (Px) is n, and n is not an integer.

In some embodiments, n substantially ranges from 2/3 to 5/3, and n is not equal to 1.

In some embodiments, a length of the second leg (Ty) is smaller than the length of the first leg (Tx).

In some embodiments, as shown in FIG. 1B, two adjacent conductive wires 201M disposed along the column direction (Y) are separated from each other by a pitch (P), and a ratio of a length of the pitch (P) to the length of the second leg (Ty) is equal to or less than 2. In some embodiments, the ratio of the length of the pitch P to the length of the second leg (Ty) may be substantially 1.

In some embodiments, a ratio of the length of the pitch (P) to a length of the second side (Py) may substantially range from 1/6 to 2.

In some embodiments, a ratio of a length of the second leg (Ty) to a length of the second side (Py) may substantially range from 1/3 to 5/3.

In some embodiments, each of the conductive wires 201M may be formed as a zigzag line or a wavy line. For example, as shown in FIG. 1B, the conductive wires 201M are zigzag metal lines.

In some embodiments, as shown in FIG. 1B, each of the conductive wires 201M may include a plurality of the first portions 201a and a plurality of the second portions 201b, and the first portions 201a and the second portions 201b are continuously connected along the row direction (Y). The first portions 201a extending in the first direction D1 and the adjacent second portions 201b extending in the second direction D2 form a plurality of bending angles Θ1 and Θ2, and the bending angles Θ1 and Θ2 can be substantially the same.

In some embodiments, the length of the first portions 201a can be the same as or different from the length of the second portions 201b. In the embodiment as shown in FIG. 1B, the lengths of the first portions 201a and the second portions 201b can be substantially the same. In the embodiment as shown in FIG. 1B, the second portion 201b may have a size and a shape substantially identical to that of the first portion 201a.

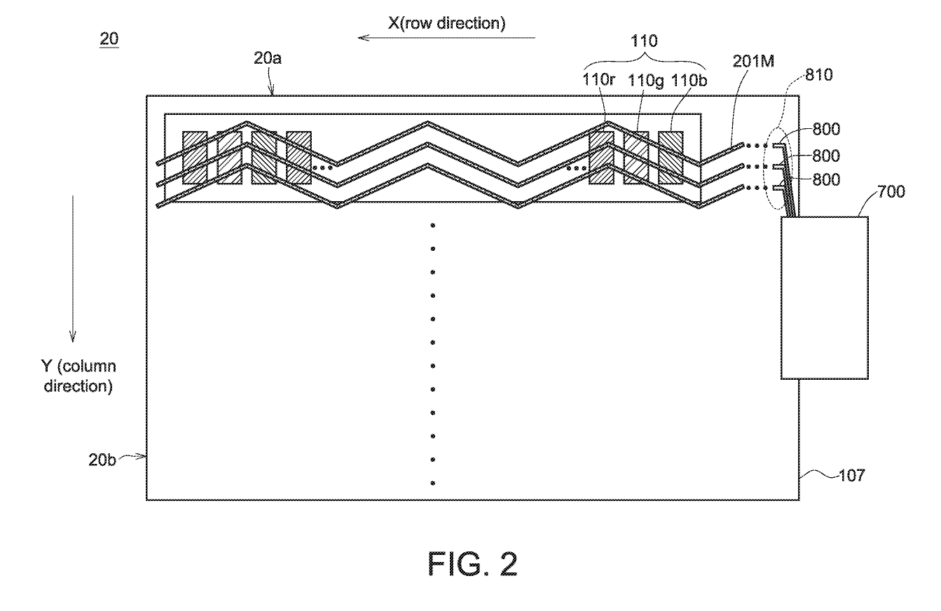

FIG. 2 is a top view of a display apparatus 20 with a touch detection function according to another embodiment of the present disclosure. The elements in the present embodiment sharing similar or the same labels with those in the previous embodiment are similar or the same elements, and the description of which is omitted.

As shown in FIG. 2, in the embodiment, the display apparatus 20 includes a second substrate 107, and the conductive wires 201M are disposed on the second substrate 107. The second substrate 107 can be a rectangular shape and includes a first edge 20a and a second edge 20b. The first edge 20a can extend along the row direction (X), the second edge 20b can extend along the column direction (Y), and the first edge 20a can be longer than the second edge 20b.

In some embodiments, the display apparatus 20 may further include a circuit board 700, and the circuit board 700 can be disposed on the substrate 107. As shown in FIG. 2, the circuit board 700 can be disposed along the second edge of the second substrate 107. The circuit board 700 can be a flexible printed circuit board.

In some embodiments, the display apparatus 20 may further include a plurality of cable wires 800, and the cable wires 800 are disposed on the substrate 107. As shown in FIG. 2, the circuit board 700 is electrically connected to the conductive wires 201M with the cable wires 800.

According to the embodiments of the present disclosure, the circuit board 700 is arranged at the shorter side (second edge 20b) of the second substrate 107, such that the lengths of the cable wires 800 extending along the shorter side can be reduced compared to the situation where the cable wires are disposed on the longer side of the substrate. In addition, the area of the twisted region 810 of the cable wires 800 can be reduced as well, resulting in minimizing the border region of the display apparatus 20, wherein the border region indicates the region between the touch active area and the substrate edge. Moreover, while the lengths of the cable wires 800 are reduced, the resistance of the cable wires 800 can be reduced as well, increasing the sensitivity and performance of the touch detection function of the display apparatus.

Arrangements of various sets of the touch detection electrodes 201 and the pixels 110 with different size parameters and results of the simulation images of the display apparatus applying the same are illustrated in the following tables. In the following tables, “G” indicates almost no moiré, “OK” indicates weak moiré, and “NG” indicates strong moiré. “G” and “OK” respectively refer to excellent and good performances.

TABLE 1

| | | Ty/Py | | | | | | |
|---|---|---|---|---|---|---|---|---|
| | | 1/3 | 1/2 | 2/3 | 1 | 4/3 | 3/2 | 5/3 |
| Tx/Px | 2/3 | OK | OK | N/A | N/A | N/A | N/A | N/A |
| | 1 | NG | NG | NG | N/A | N/A | N/A | N/A |
| | 4/3 | G | G | G | G | N/A | N/A | N/A |
| | 5/3 | G | G | G | G | G | N/A | N/A |
| | 2 | NG | NG | NG | NG | G | G | G |

TABLE 2

| | | P/Py | | | | | | | |
|---|---|---|---|---|---|---|---|---|---|
| | | 1/6 | 1/4 | 1/3 | 1/2 | 2/3 | 1 | 3/2 | 2 |
| (Tx/Px, | (2/3, | OK | N/A | N/A | N/A | G | N/A | N/A | N/A |
| Ty/Py) | 1/3) | | | | | | | | |
| | (2/3, | N/A | OK | N/A | N/A | N/A | OK | N/A | N/A |
| | 1/2) | | | | | | | | |
| | (4/3, | G | N/A | N/A | N/A | G | N/A | N/A | N/A |
| | 1/3) | | | | | | | | |
| | (4/3, | N/A | G | N/A | N/A | N/A | G | N/A | N/A |
| | 1/2) | | | | | | | | |
| | (4/3, | N/A | N/A | G | G | N/A | N/A | G | G |
| | 1) | | | | | | | | |

In some embodiments of the present disclosure, applying the touch detection electrodes 201 and the pixels 110 with specific size parameters can compensate color phase shift caused by the light shielding of the touch detection electrodes 201 especially when the view angle of the user is changed.

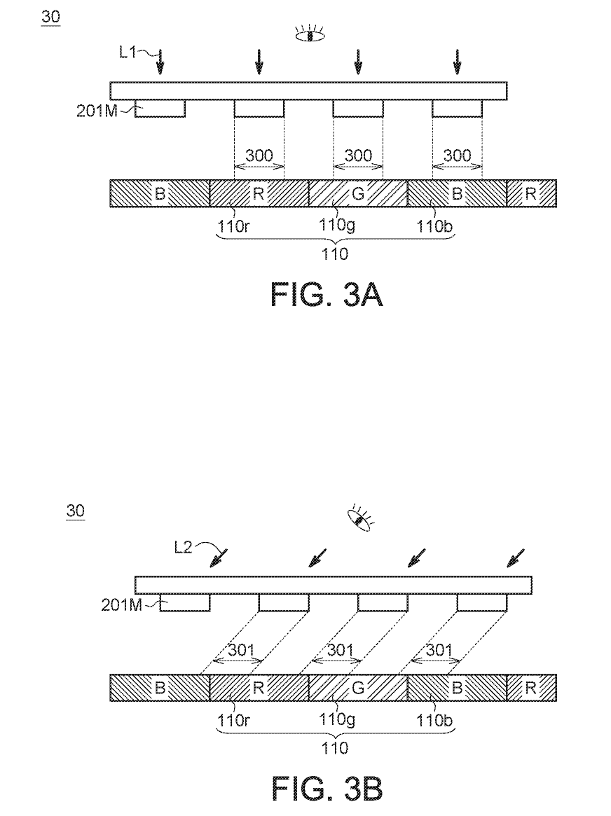

FIGS. 3A and 3B are simplified cross-sectional views of a display apparatus 30 according to an embodiment of the present disclosure, illustrating the shadow coverage of the conductive wires 201M casted on the pixels 110 of the display apparatus 30 observed at different view angles. The elements in the present embodiment sharing similar or the same labels with those in the previous embodiment are similar or the same elements, and the description of which is omitted.

As shown in FIG. 3A, when a user views the display apparatus 30 with a first view angle, for example, right view angle (or vertical view angle), light L1 vertically comes towards the display apparatus 30 and a vertical shadow 300 of the conductive wires 201M can be casted on the pixels 110. As shown in FIG. 3B, when the user views the display apparatus 30 with a second view angle, for example, an oblique view angle, light L2 obliquely comes towards the display apparatus 30, an oblique shadow 301 of the conductive wires 201M can be casted on the pixels 110 and the shadow coverage may shift to the left. If the position of shadow coverage of the oblique shadow 301 is changed from the position of shadow coverage of the vertical shadow 300 casted on the color regions (such as color regions 110r, 110g or 110b), color phase shift of the displayed images may occur.

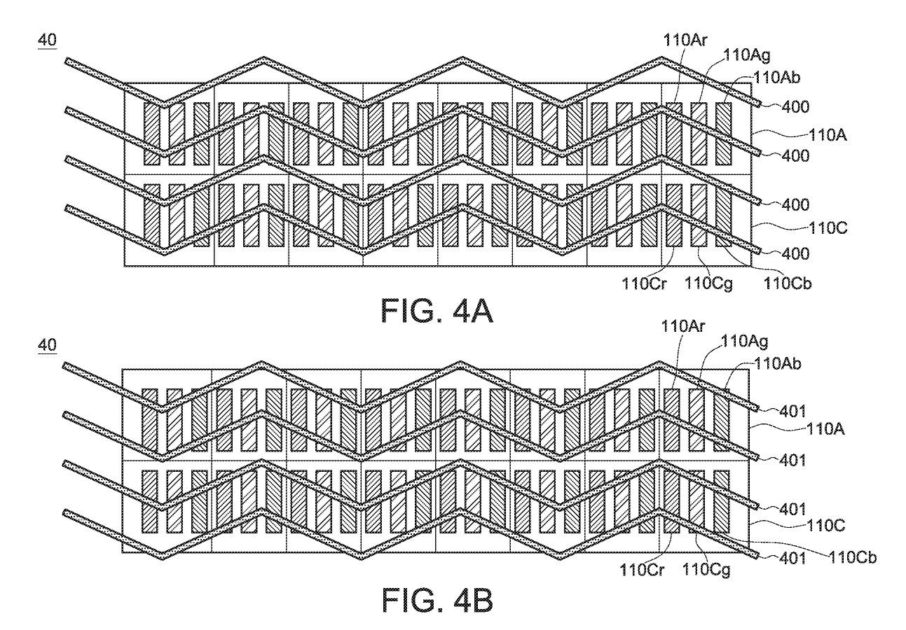

FIGS. 4A and 4B are top views of a display apparatus 40 according to an embodiment of the present disclosure, illustrating the shadow coverage of the conductive wires 201M casted on pixels of the display apparatus 40 at a vertical view angle and at an oblique view angle of upward direction. The two adjacent pixels 110A and 1100 are arranged along the column direction. In the embodiment as shown in FIGS. 4A-4B, Tx=(4/3)*Px, Ty=(2/3)*Py, and pitch P=Ty. The elements in the present embodiment sharing similar or the same labels with those in the previous embodiment are similar or the same elements, and the description of which is omitted.

FIG. 4A illustrates the vertical shadow 400 of the conductive wires 201M of the touch detection electrodes 201 casted on pixels at the vertical view angle, and FIG. 4B illustrates the oblique shadow 401 of the conductive wires 201M of the touch detection electrodes 201 casted on pixels at the oblique view angle. As shown in FIGS. 4A-4B, when the view angle is changed, the shadow coverage may shift downwardly.

As shown in FIGS. 4A-4B, due to the design of the non-linear shape of the conductive wires 201M, the conductive wires 201M are not parallel to the pattern of the shielding region 110s, such that despite the view angle is changed, the vertical shadow 400 as well as the oblique shadow 401 are uniformly casted on the color regions with different colors and the shielding region 110s. Specifically speaking, referring to two adjacent pixels 110A and 110C disposed along the column direction, the total shadow coverage of the oblique shadow 401 casted on the color regions 110Ar and 110Cr with red color in these two adjacent pixels 110A and 110C is substantially equal to the total shadow coverage of the vertical shadow 400 casted on the same color regions 110Ar and 110Cr; the total shadow coverage of the oblique shadow 401 casted on the color regions 110Ag and 110Cg with green color in these two adjacent pixels 110A and 110C is substantially equal to the total shadow coverage of the vertical shadow 400 casted on the same color regions 110Ag and 110Cg; and the total shadow coverage of the oblique shadow 401 casted on the color regions 110Ab and 110Cb with blue color in these two adjacent pixels 110A and 1100 is substantially equal to the total shadow coverage of the vertical shadow 400 casted on the same color regions 110Ab and 110Cb. As result, the color phase shift occurring on the display apparatus 40 due to the change of view angle can be compensated when the two adjacent pixels 110A and 110C are viewed as a whole.

In summary, according to some embodiments, even though the user changes view angle, due to the non-linear shape (zigzag shape) of the conductive wires 201M, the difference of total shielding areas by the conductive wires casted on the pixels can be minimized, and thus the moiré can be minimized.

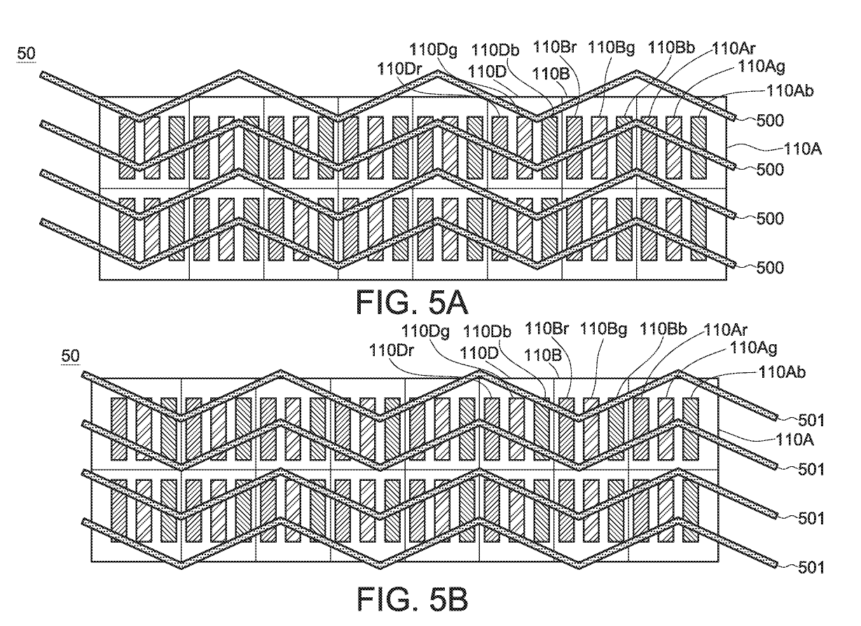

FIGS. 5A and 5B are top views of a display apparatus 50 according to another embodiment of the present disclosure, illustrating the shadows coverage of the conductive wires 201M casted on pixels of the display apparatus 50 respectively at a vertical view angle and at an oblique view angle of left direction. In the embodiment as shown in FIGS. 5A-5B, Tx=(4/3)*Px, Ty=(2/3)*Py, and pitch P=Ty. The elements in the present embodiment sharing similar or the same labels with those in the previous embodiment are similar or the same elements, and the description of which is omitted.

FIG. 5A illustrates the vertical shadow 500 of the conductive wires 201M of the touch detection electrodes 201 casted on pixels observed at the vertical view angle, and FIG. 5B illustrates the oblique shadow 501 of the conductive wires 201M of the touch detection electrodes 201 casted on the pixels observed at the oblique view angle. As shown in FIGS. 5A-5B, when the view angle is changed, the shadow coverage may shift to the right.

As shown in FIGS. 5A-5B, due to the design of the non-linear shape of the conductive wires 201M and the design of Tx=n*Px where n is not an integer, such that despite the view angle is changed, the vertical shadow 500 as well as the oblique shadow 501 are uniformly casted on the color regions with different colors and the shielding region 110s. Specifically speaking, referring to three adjacent pixels 110A, 110E and 110D disposed along the row direction, the total shadow coverage of the oblique shadow 501 casted on the color regions 110Ar, 110Br and 110Dr with red color in these three adjacent pixels 110A, 110B and 110D is substantially equal to the total shadow coverage of the vertical shadow 500 casted on the same color regions 110Ar, 110Br and 110Dr; the total shadow coverage of the oblique shadow 501 casted on the color regions 110Ag, 110Bg and 110Dg with green color in these three adjacent pixels 110A, 110B and 110D is substantially equal to the total shadow coverage of the vertical shadow 500 casted on the same color regions 110Ag, 110Bg and 110Dg; and the total shadow coverage of the oblique shadow 501 casted on the color regions 110Ab, 110Bb and 110Db with blue color in these three adjacent pixels 110A, 110B and 110D is substantially equal to the total shadow coverage of the vertical shadow 500 casted on the same color regions 110Ab, 110Bb and 110Db. As result, the color phase shift occurring on the display apparatus 50 due to the change of view angle can be compensated when the three adjacent pixels 110A, 110B and 110D are viewed as a whole.

In summary, according to some embodiments, even though the user changes view angle, due to the non-linear shape (zigzag shape) of the conductive wires 201M, the difference of total shadow coverage by the conductive wires casted on the pixels can be minimized, and thus the moiré can be minimized.

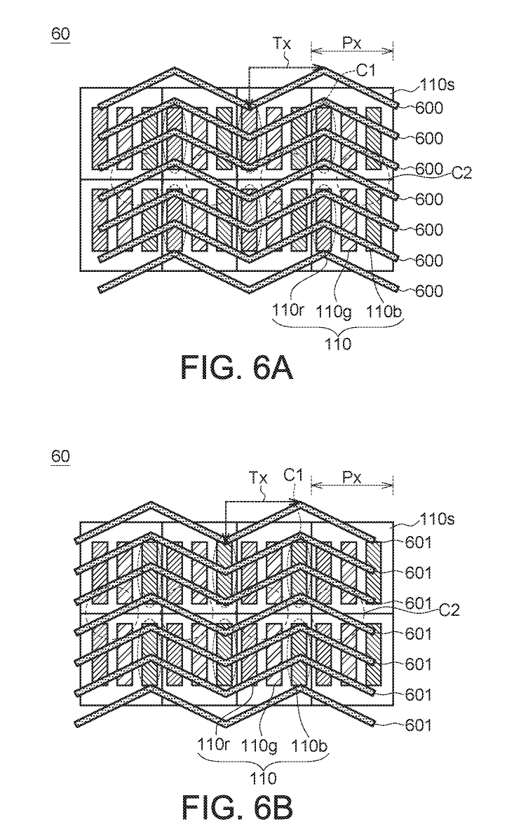

FIGS. 6A and 6B are top views of a display apparatus 60 according to a comparative embodiment, illustrating the shadow coverage of touch detection electrodes casted on pixels 110 of the display apparatus 60 respectively at a vertical view angle and at an oblique view angle of right direction. In the comparative embodiment as shown in FIGS. 6A-6B, Tx=Px, Ty=(1/3)*Py, and pitch P=Ty. The elements in the present embodiment sharing similar or the same labels with those in the previous embodiment are similar or the same elements, and the description of which is omitted.

FIG. 6A illustrates the vertical shadow 600 of the conductive wires casted on the pixels 110 observed at the vertical view angle, and FIG. 6B illustrates the oblique shadow 601 of the conductive wires casted on the pixels 110 observed at the oblique view angle. As shown in FIGS. 6A-6B, when the view angle is changed, the shadow coverage may shift to the left.

As shown in FIGS. 6A-6B, when the ratio of the length of the first leg (Tx) to the length of the first side (Px) is integer, the vertical shadow 600 and the oblique shadow 601 are non-uniformly casted on the color regions with different colors and the shielding region 110s.

For example, as shown in FIG. 6A, the vertical shadow 600 includes two coverage regions C1 and C2 respectively located on the color regions 110r and the shielding region 110s, such that the shadow coverage of the vertical shadow 600 casted on the color regions 110r is larger than the shadow coverage of the vertical shadow 600 casted on the color regions 110g and the shadow coverage of the vertical shadow 600 casted on the color regions 110b. When the view angle is changed, as shown in FIG. 6B, the oblique shadow 601 includes two coverage regions C1 and C2 respectively located on the color regions 110b and the shielding region 110s, such that the shadow coverage of the oblique shadow 601 casted on the color regions 110b is larger than the shadow coverage of the oblique shadow 601 casted on the color regions 110r and the shadow coverage of the oblique shadow 601 casted on the color regions 110g.

As such, as shown in FIGS. 6A-6B, when the ratio of the length of the first leg (Tx) to the length of the first side (Px) is integer, the shadow coverage (area) of the oblique shadow 601 is different from the shadow coverage (area) of the vertical shadow 600 casted on the color regions (such as color regions 110r, 110g or 110b) with the same color, color phase shift would occur, and the image of the display apparatus 60 would reveal strong moiré effect.

According to some embodiments, the touch electrodes are designed with a special shape and with a specific size corresponding to the pixel size, moiré effect can be alleviated or eliminated. It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A display apparatus with touch detection function, comprising:
a display medium comprising a plurality of pixels, each of the pixels comprising a plurality of color regions with different colors, arranged in a matrix with a plurality of rows and columns, wherein each of the pixels has a first side (Px) along a row direction and a second side (Py) along a column direction; and
a plurality of touch electrodes disposed corresponding to the display medium, at least one of the touch electrodes comprising a plurality of conductive wires, the conductive wires extending along the row direction, wherein at least one of the conductive wires comprises at least one first portion extending in a first direction and at least one second portion connecting to the first portion and extending in a second direction, and the first direction is different from the second direction, wherein the first direction is different from the row direction and the column direction, and the second direction is different from the row direction and the column direction;
wherein the first portion crosses at least one pixel and serves as a hypotenuse of a right triangle with a first leg (Tx) parallel to the row direction and a second leg (Ty) parallel to the column direction, a ratio of a length of the first leg (Tx) to a length of the first side (Px) is n, and n is not an integer.

2. The display apparatus with touch detection function according to claim 1, wherein in substantially ranges from 2/3 to 5/3, and n is not equal to 1.

3. The display apparatus with touch detection function according to claim 1, wherein a length of the second leg (Ty) is smaller than the length of the first leg (Tx).

4. The display apparatus with touch detection function according to claim 1, wherein two adjacent conductive wires disposed along the column direction are separated from each other by a pitch, and a ratio of a length of the pitch to a length of the second leg (Ty) is equal to or less than 2.

5. The display apparatus with touch detection function according to claim 4, wherein the ratio of the length of the pitch to the length of the second leg (Ty) is substantially 1.

6. The display apparatus with touch detection function according to claim 4, wherein a ratio of the length of the pitch to a length of the second side (Py) substantially ranges from 1/6 to 2.

7. The display apparatus with touch detection function according to claim 1, wherein a ratio of a length of the second leg (Ty) to a length of the second side (Py) substantially ranges from 1/3 to 5/3.

8. The display apparatus with touch detection function according to claim 1, wherein each of the conductive wires includes a plurality of the first portions and a plurality of the second portions, the first portions and the second portions are continuously connected along the row direction.

9. The display apparatus with touch detection function according to claim 8, wherein the first portions extending in the first direction and the adjacent second portions extending in the second direction form a plurality of bending angles, and the bending angles are substantially the same.

10. The display apparatus with touch detection function according to claim 1, wherein the second portion has a size and a shape identical to that of the first portion.

11. The display apparatus with touch detection function according to claim 1, wherein each of the conductive wires is formed as a zigzag line or a wavy line.

12. The display apparatus with touch detection function according to claim 1, further comprising a substrate, wherein the conductive wires are disposed on the substrate, and wherein the substrate comprises a first edge along the row direction and a second edge along the column direction, and the first edge is longer than the second edge.

13. The display apparatus with touch detection function according to claim 12, further comprising:
a circuit board disposed on the substrate, wherein the circuit board is disposed along the second edge of the display surface.

14. The display apparatus with touch detection function according to claim 13, further comprising:
a color filter layer disposed on the substrate.
